(19) United States
(12) Patent Application Publication
(10) Pub. No.: US 2002/0008522 A1
(43) Pub. Date: Jan. 24, 2002

(54) Detector for the measurement of electrolytic conductivity

(76) Inventors: Erhard Schnell, Innsbruck (AT); Andreas Zemann, Innsbruck (AT); Dietmar Volgger, Wattens (AT); Guenther K. Bonn, Zirl (AT)

Correspondence Address: BIRCH STEWART KOLASCH & BIRCH, PO BOX 747, FALLS CHURCH, VA, 22040-0747, US

(21) Appl. No.: 09/963,612

(22) Filed: Sep. 27, 2001

Related U.S. Application Data
(63) Continuation of application No. 09/458,099, filed on Dec. 10, 1999.
Application No. 09/458,099 is a continuation of application No. PCT/AT98/00142, filed on Dec. 17, 1998.

(30) Foreign Application Priority Data
Jun. 12, 1997 (AT) 1016/97

(51) Int. Cl. G01N 27/42

(52) U.S. Cl. 324/425

(57) ABSTRACT

A detection device which measures the electrolytic conductivity of a fluid in a small tube or a capillary, including first and second electrodes which are both located outside the tube or capillary and placed along the path of the liquid in a longitudinal direction of the tube or capillary and separated from each other by a distance along the tube or capillary. The first and second electrodes are adapted to be connected to an AC power source and coupled to a processing device.

### CROSS REFERENCE TO RELATED APPLICATIONS

This applications claims priority to PCT Application No. PCT/AT98/00142 filed Jun. 10, 1998 and Austrian Patent Application No. A 1016/97 filed Jun. 12, 1997, the entire contents of both of which are incorporated by reference herein.

### BACKGROUND OF THE INVENTION

1. Field of the Invention

The invention relates to a detection device or the measurement of the electrolytic conductivity of a liquid inside a small tube or a capillary including a first and second electrode that are connected to a DC source and a processing device which are both located outside the tube or capillary.

2. Discussion of Background

Such detection devices are particularly used for the detection and quantitative determination of ions which have previously been separated by capillary electrophoresis or chromatography.

A similar detection device has been reported by Vacik et al. [Journal of Chromatography 320 (1985) 233-240]. This detector has four electrodes which are oppositely arranged outside a glass tube in a way, that at two electrodes a high frequency contact between the electrodes and the solution, this detector has the advantage of not being contaminated or otherwise affected by components of the solution. However, the detector is complicated in its construction and has the further disadvantage of using rather high frequencies which causes the system no only to detect the electrolytic resistance but also the capacitive reactance. In addition, by using capillaries with inner diameters between 50 and 100 mm the measurement of the conductivity across the flow direction becomes difficult and laborious. Furthermore, by using lower frequencies the area of the electrodes would have to be significantly enlarged which would lead to a larger sample volume and, as a consequence. to a decreased resolution.

### SUMMARY OF THE INVENTION

Accordingly, an object of this invention is to provide an improved detection device compared to the described sort.

This is achieved with a detection device mentioned at the beginning in a way that the first and the second electrode are arranged longitudinally along the path of the liquid in the tube or capillary and placed at a distance from each other.

The electrodes can favorably consist of a metal tube or a conducting coating which surround the tube or capillary.

Using this arrangement, a surprisingly good effect is reached with small sample volumes. Due to the considerably longer electrodes (preferably 10-30 mm) a significantly lower frequency of the oscillator voltage, which is in the audio or ultrasonic range (preferably in the range between 15 and 20 kHz) and be used. As a consequence, the electrolytic resistance of the liquid along a small distance between the electrodes can be determined without a considerable contribution of the capacitive reactance.

In addition, by variation of the distance between the first and the second electrode the separation resolution and the separation efficiency, respectively, of the detector can be adjusted.

In a preferred embodiment, the electrodes surround the small tube or capillary cylindrically.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings wherein:

FIG. 1 shows a schematic representation of the detection device according to the present invention:

FIG. 2 is a simplified wiring diagram of the electrode arrangement of the detection device according to the present invention; and

FIG. 3 is a graph providing a comparison of electrophoretic separations obtained with a conventional UV detector and with the detection device according to the present invention.

### DESCRIPTION OF THE PREFERRED EMBODIMENTS

Referring now to the drawings and more particularly to FIG. 1 thereof, in FIG. 1 there is shown a tube or capillary (1) which consists of fused silica, glass, or a synthetic material, and in which a liquid is located, the electrolytic conductivity of which is determined in order to detect or quantitatively determine ions which have been separated by electrophoresis or chromatography. The capillary (1) is connected to a conventional system to perform electrophoresis or chromatography.

The first electrode (3) and the second electrode (4) are arranged outside the capillary (1) and via connections 5 and 6 connected to an oscillator as the source of the AC voltage, which is not shown in FIG. 1. The first and the second electrodes (3, 4) are located longitudinally along the path of the liquid inside the capillary. The electrodes (3, 4) surround the capillary (1) as a cylindrical cover and are of the length (D) which is in a range of 0.5 to 7 cm, preferably between 2 and 3 cm. The distance (d) between the electrodes (3, 4) depends on the desired separation resolution and separation efficiency and is in the range between 1 and 7 mm, preferably between 2 and 5 mm.

The signal is measured as voltage drop at the resistor (7), e.g. 10 kV, and amplified and rectified by means of an amplifier (8) and a rectifier (9). Instead of the resistor (7) a capacitor could be used as well. The amplified and rectified signal is then brought e.g. to an AD converter and a processor for display by means of a connection (10).

Due to the fact that the voltage drop at resistor (7) is in the range of 1 mV or less, the detector and all the connections are shielded against ground. To measure the difference of the conductivity of the electrolyte and the separated ions, a zero compensation is already known form detectors which are used by detectors measuring the indirect UV absorbance or the conductivity by means of a direct galvanic contact of the electrodes and the liquid.

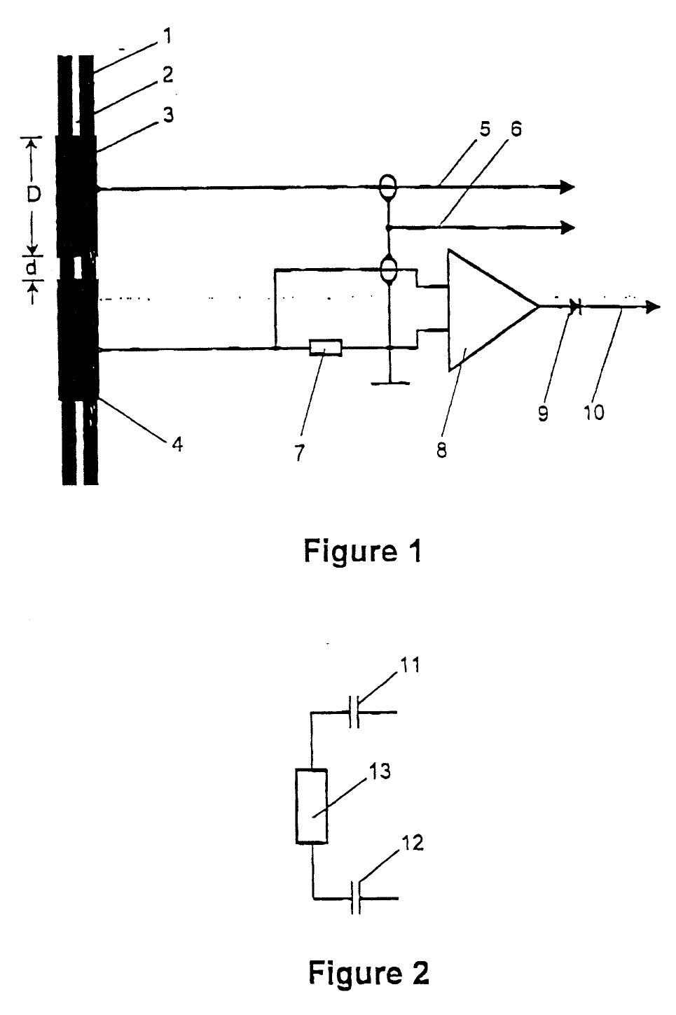

As depicted in FIG. 2, the electrode arrangement together with the liquid (2) inside the capillary 1) can also be presented by means of a wiring diagram as two capacitors (11, 12) with an ohmic resistor (13) placed in between. The capacitors (11, 12) are formed by one electrode and the liquid (2) adjacent to the electrodes (3, 4). Resistance (13) is formed by the liquid (2) between the electrodes (3, 4). Due to the relatively large length of the electrodes (3, 4) in the range between 0.5 and 7 cm, preferably between 2 and 3 cm, the frequency of the AC voltage which is applied to the electrodes (3, 4) can be kept low in the range of audio or low ultrasonic frequency, respectively (e.g. in the range between 15 and 40 kHz). The alternating current can be of sinusoidal form as well as of other forms, such as rectangular.

The electrodes can be either a conducting varnish applied to the outside of the small tube or capillary. Furthermore, a metallic layer could be attached to the tube or capillary as well, e.g. by vapor-metallization, or two metallic tubes could be used which inner diameters are adjusted in size to the outer diameter of the capillary.

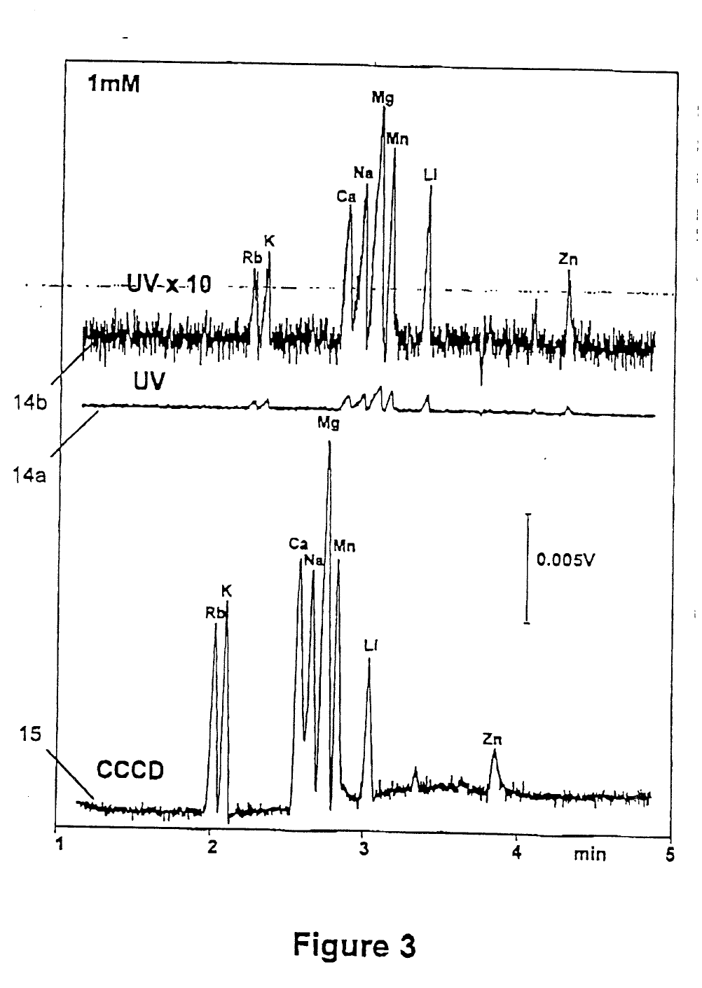

Referring to FIG. 3 a comparison can be made of curve (15) which was obtained using the detector according to the present invention, and curve 14a and 14b which obtained by using conventional indirect UV detection. Using an electrolyte consisting of 20 mM 2-morpholinoethanesulfonic acid and 20 mM histidine at pH 6.0, a separation of eight inorganic cations can be detected. It can be seen that curve 14a has to be enlarged by factor of 10 (curve 14b) to obtain structures which resemble the structures of curve 15, which was obtained by the detector according to the present invention. Thus, it is seen that the baseline noise in curve 14b is much higher than in curve 15.

A modification of the length of the electrodes (D) between 2 and 3 cm did not result in a significant altered detection signal, however, with shorter lengths of the electrodes (D) the amplification of the amplifier (8) had to be increased which itself slightly increased the baseline noise.

Numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A detection device which measures the electrolytic conductivity of a fluid in a tube or a capillary, comprising:
first and second electrodes located outside the tube or capillary and disposed separated by a distance from each other along the path of the liquid in a longitudinal direction of the tube or capillary, said first and second electrodes configured to be connected to an AC power source and a processing device.

2. The detection device of claim 1, in which at least one of the first and second electrodes cylindrically surrounds the tube or capillary.

3. The detection device of claim 1, in which the first and second electrodes have a length (D) in contact with the tube or capillary in a range between 0.5 and 7 cm.

4. The detection device of claim 1, in which the first and second electrodes have a length (D) in contact with the tube or capillary in a range between 2 and 3 cm.

5. The detection device of claim 1, in which the first and second electrodes are separated by a distance (d) along the tube or capillary, wherein (d) is a fraction of the length (D) of the first and second electrodes.

6. The detection device of claim 5, in which the distance (d) between the first and second electrodes is in a range between 1 and 7 mm.

7. The detection device of claim 5, in which the distance (d) between the first and second electrodes is in a range between 2 and 5 mm.

8. The detection device of claim 2, in which the first and second electrodes are separated by a distance (d) along the tube or capillary, wherein (d) is a fraction of the length (D) of the first and second electrodes.

9. The detection device of claim 8, in which the distance (d) between the first and second electrodes is in a range between 1 and 7 mm.

10. The detection device of claim 8, in which the distance (d) between the first and second electrodes is in a range between 2 and 5 mm.

11. The detection device of claim 3, in which the first and second electrodes are separated by a distance (d) along the tube or capillary, wherein (d) is a fraction of the length (D) of the first and second electrodes.

12. The detection device of claim 11, in which the distance (d) between the first and second electrodes is in a range between 1 and 7 mm.

13. The detection device of claim 11, in which the distance (d) between the first and second electrodes is in a range between 2 and 5 mm.

14. The detection device of claim 4, in which the first and second electrodes are separated by a distance (d) along the tube or capillary, wherein (d) is a fraction of the length (D) of the first and second electrodes.

15. The detection device of claim 14, in which the distance (d) between the first and second electrodes is in a range between 1 and 7 mm.

16. The detection device of claim 14, in which the distance (d) between the first and second electrodes is in a range between 2 and 5 mm.

17. The detection device of claim 1, in which the frequency of an alternating current which is applied to the first and second electrode is in a range of between 15 and 20 kHz.

18. The detection device of claim 2, in which the frequency of an alternating current which is applied to the first and second electrode is in a range of between 15 and 20 kHz.

19. The detection device of claim 3, in which the frequency of an alternating current which is applied to the first and second electrode is in a range of between 15 and 20 kHz.

20. The detection device of claim 4, in which the frequency of an alternating current which is applied to the first and second electrode is in a range of between 15 and 20 kHz.

21. The detection device of claim 5, in which the frequency of an alternating current which is applied to the first and second electrode is in a range of between 15 and 20 kHz.

22. The detection device of claim 6, in which the frequency of an alternating current which is applied to the first and second electrode is in a range of between 15 and 20 kHz.

23. The detection device of claim 7, in which the frequency of an alternating current which is applied to the first and second electrode is in a range of between 15 and 20 kHz.

24. The detection device of claim 8, in which the frequency of an alternating current which is applied to the first and second electrode is in a range of between 15 and 20 kHz.

25. The detection device of claim 9, in which the frequency of an alternating current which is applied to the first and second electrode is in a range of between 15 and 20 kHz.

26. The detection device of claim 10, in which the frequency of an alternating current which is applied to the first and second electrode is in a range of between 15 and 20 kHz.

27. The detection device of claim 11, in which the frequency of an alternating current which is applied to the first and second electrode is in a range of between 15 and 20 kHz.

28. The detection device of claim 12, in which the frequency of an alternating current which is applied to the first and second electrode is in a range of between 15 and 20 kHz.

29. The detection device of claim 13, in which the frequency of an alternating current which is applied to the first and second electrode is in a range of between 15 and 20 kHz.

30. The detection device of claim 14, in which the frequency of an alternating current which is applied to the first and second electrode is in a range of between 15 and 20 kHz.

31. The detection device of claim 15, in which the frequency of an alternating current which is applied to the first and second electrode is in a range of between 15 and 20 kHz.

32. The detection device of claim 16, in which the frequency of an alternating current which is applied to the first and second electrode is in a range of between 15 and 20 kHz.
